(19) United States
(12) Patent Application Publication
(10) Pub. No.: US 2007/0293635 A1
(43) Pub. Date: Dec. 20, 2007

(54) Alkanoic Acid Ester Monomer Compositions and Methods Of Making Same

(76) Inventors: Robert S. Whitehouse, Lexington, MA (US); Luhua Zhong, Woburn, MA (US); Sean Daughtry, Roxbury, MA (US)

Correspondence Address: KILYK & BOWERSOX, P.L.L.C., 400 HOLIDAY COURT, SUITE 102, WARRENTON, VA, 20186, US

(21) Appl. No.: 11/846,179

(22) Filed: Aug. 28, 2007

Related U.S. Application Data
(62) Division of application No. 09/999,768, filed on Oct. 25, 2001.
(60) Provisional application No. 60/243,823, filed on Oct. 27, 2000.

(51) Int. Cl. C07B 41/00

(52) U.S. Cl. 525/450

(57) ABSTRACT

An alkanoic acid ester monomer is provided having a number average molecular weight of about 1000 or less. Coalescing agents, plasticizers, and green solvents including the monomer are also provided as are methods of making the monomer. In addition, methods of coalescing components, plasticizing compositions, and dissolving solutes using the monomer are also provided.

This application is a divisional of U.S. patent application Ser. No. 09/999,768, filed Oct. 25, 2001, which in turn claims the benefit under 35 U.S.C. § 119(e) of prior U.S. Provisional Patent Application No. 60/243,823 filed Oct. 27, 2000, which are incorporated in their entirety by reference herein.

### BACKGROUND OF THE INVENTION

The present invention relates to alkanoic acid ester compositions, solvents including the compositions, and methods of using the compositions.

With a view to the environment, a serious need has arisen for biologically degradable products. Ester compositions find use in many industrial chemical processes, and thus, there is a need for ester compositions having improved biodegradation characteristics and for ester compositions that can be generated from non-oil based feedstocks.

In addition, coalescing agents are commonly used to promote film formation from latex compositions such as paints. A need exists for a coalescing agent that can be used to promote film formation from latex compositions having low volatility that is biodegradable. It would also be desirable to provide a method of making a biodegradable ester composition, particularly one that can be used as a coalescing solvent.

Furthermore, solvents, plasticizers, and surface active agents are used in many commercial and industrial compositions including paints, coatings, and inks. It would also be desirable to provide environmentally friendly solvents, plasticizers, and surface active agents for such compositions that are biodegradable.

U.S. Pat. No. 6,008,184 to Pluyter et al. relates to fabric softening compositions that incorporate a block copolymer containing a hydrophobic backbone with one or more hydrophilic side chains in the presence of a non-ionic water soluble polymer. The compositions are identified as providing viscosity stabilization but are not identified as being biodegradable. One of the monomers identified for use in the composition is poly(3-hydroxybutyric acid) having from 4 degrees to 50 degrees of polymerization.

All of the patents, patent applications, and publications mentioned throughout this application are incorporated in their entirety by reference herein and form a part of the present application.

### SUMMARY OF THE INVENTION

It is an object of the present invention to provide alkanoic acid ester monomers.

It is a further object of the present invention to provide dihydroxy alkanoic acid ester monomers.

It is a further object of the present invention to provide alkanoic acid ester alkoxylate monomers.

It is yet a further object of the present invention to provide green solvents and coalescing solvents that are biodegradable.

It is yet a further object of the present invention to provide plasticizers and surface active agents that are biodegradable.

It is yet another object of the present invention to provide a method of coalescing components in a liquid mixture.

It is yet a further object of the present invention to provide a method of mixing a solute with, or dissolving a solute in, a biodegradable and environmentally-friendly green solvent that exhibits low toxicity and low volatility.

Additional features and advantages of the present invention will be set forth in part in the description which follows, and in part will be apparent from the description, or may be learned by practice of the present invention. The objectives and other advantages of the present invention will be realized and obtained by means of the elements and combinations particularly pointed out in the written description and appended claims.

The foregoing and other objects are achieved according to the present invention by providing alkanoic acid ester monomers of low molecular weight and compositions containing the same. The alkanoic acid ester monomers of the present invention preferably have number average molecular weights ranging from about 100 to about 1,000. The monomers are preferably biodegradable.

The present invention further relates to coalescing solvents, green solvents, alkanoic ester alkoxylate monomers and dihydroxy alkanoic acid ester monomers and compositions containing the same.

The present invention also relates to a method for producing alkanoic acid ester monomers through the hydrolysis of polyhydroxyalkanoates, preferably under conditions that produce low molecular weight monomers (having number average molecular weights of under about 1,000) and preferably under conditions that produce monomers of the formulae (I)-(X) shown below. Preferably, the alkanoic acid ester monomers produced are biodegradable.

The present invention also relates to methods of producing dihydroxy alkanoic acid ester monomers and alkanoic acid ester alkoxylate monomers by hydrolysis of polyhydroxyalkanoates, preferably under conditions that produce low molecular weight monomers, and preferably under conditions that produce such monomers of the formulae (I)-(X) shown below. Preferably, the dihydroxy alkanoic acid ester monomers and the alkanoic acid ester alkoxylates produced are biodegradable.

The present invention also provides compositions having a coalescing agent that includes an alkanoic acid ester monomer of the present invention, and methods of coalescing components in a liquid mixture by combining the liquid mixture with an alkanoic acid ester monomer according to the present invention.

The present invention also provides compositions having a plasticizer that includes an alkanoic acid ester monomer of the present invention, and methods of plasticizing components in a liquid mixture by combining the liquid mixture with an alkanoic acid ester monomer according to the present invention. The plasticizers of the present invention are particularly useful in polyvinylacetate (PVA) compositions, polyvinylchloride (PVC) compositions, polyester compositions, polyamide compositions, and polystyrene compositions.

In addition, the present invention provides solutions containing a solvent that includes an alkanoic acid ester monomer of the present invention and a solute mixed with or dissolved in the monomer, and methods of mixing a solute with, or dissolving a solute in, a biodegradable and environmentally-friendly green solvent that exhibits low toxicity and that includes an alkanoic acid ester monomer according to the present invention.

It is to be understood that both the foregoing general description and the following detailed description are exemplary and explanatory only and are intended to provide further explanation of the present invention, as claimed.

### DETAILED DESCRIPTION OF THE PRESENT INVENTION

The present invention relates, in part to alkanoic acid ester monomers and compositions containing the same. The alkanoic acid ester monomers of the present invention preferably have number average molecular weights ranging from about 1000 or less and more preferably from about 100 to about 1000.

The alkanoic acid ester monomer preferably has a formula selected from:
HOCHR(CH₂)_{y}COO A OH (I)
H{OCHR(CH₂)_{y}CO}ₓO A OH (II)
HOCHR(CH₂)COO A OOC(CH₂)_{y}CHROH (III)
H{OCHR(CH₂)_{y}CO}ₓOAO{OC(CH₂)_{y}CHRO}ₓH (IV)
{HOCHR(CH₂)_{y}CO}ₓB (V)
[H{OCHR(CH₂)_{y}CO}ₓ]_{z}B (VI) or
T-[—OCR¹R²(CR³R⁴)ₙCO—]ₚ-Q (VII)
wherein each R, which can be the same or different, is independently selected from hydrogen, a saturated alkyl group having from about 1 to about 16 carbon atoms, an unsaturated alkyl group having from about 2 to about 16 carbon atoms, or mixtures thereof; A is (CH₂)ₘ or (CH₂CHR′O)ₘ, where m is from about 1 to about 100 and R′ is hydrogen or methyl or mixtures thereof; x is from about 2 to about 25; y is from 0 to about 3; z is from about 1 to about 5; B is selected from:

trimethylol propane when z is 1, 2, 3, or a mixture of 1, 2, and/or 3,

glycerol when z is 1, 2, 3 or a mixture of 1, 2, and/or 3,

triethanolamine when z is 1, 2, 3 or a mixture of 1, 2, and/or 3, or

sucrose when z is 1 to p, preferably 1 to (p−1), where p is the number of free hydroxyl groups or derivatives present in said compound;

R¹, R², R³, and R⁴, which are the same as each other or different from one another, are each independently selected from saturated and unsaturated hydrocarbon radicals, halo- and hydroxy-substituted radicals, hydroxy radicals, halogen radicals, nitrogen-substituted radicals, oxygen-substituted radicals, or hydrogen atoms; n is from 0 to about 50, preferably from 0 to about 5; p is from 0 to about 25; Q is selected from:

a hydroxy radical or an OR″ radical wherein R″ is a substituted or unsubstituted alkyl, aryl, alkaryl, or aralkyl radical containing from about 1 to about 20 carbon atoms, and R″ is preferably substituted;
OAOH;
OAOOC(CH₂)_{y}CHROH;
OAO{OC(CH₂)_{y}CHRO}ₓH; or
B; and
T is selected from hydrogen, an alkyl, aryl, alkaryl, or aralkyl group containing from about 1 to about 20 carbon atoms, or an R′″COO carboxylate group wherein R′″ is an aliphatic or aromatic hydrocarbon radical containing from about 1 to about 20 carbon atoms.

Suitable units that can be included as structural units within the alkanoic acid ester monomers of the present invention include the units: hydroxybutyrate, hydroxyvalerate, hydroxyhexanoate, hydroxyheptanoate, hydroxypropanoate, hydroxyoctanoate, hydroxynonanoate, hydroxydecanoate, hydroxyundecanoate, and hydroxydodecanoate units. PHAs including monomers and polymers (homopolymers, copolymers, and the like) and derivatives of 3-hydroxyacids, 4-hydroxyacids, 5-hydroxyacids, polylactic acid, and polyglycolic acid, and combinations thereof.

Preferably, the alkanoic acid ester monomer has one of the following formulae:
a) HOCHR(CH₂)_{y}COO A OH wherein R is hydrogen, a saturated alkyl group having from about 1 to about 16 carbon atoms or an unsaturated alkyl group having from about 2 to about 16 carbon atoms or mixtures thereof, A is (CH₂)ₙ where n is about 2 to about 6 or A is (CH₂CHR′O)ₘ where R′ is hydrogen or methyl, m is from about 1 to about 25, and y is 0 to about 3;
b) H{OCHR(CH₂)_{y}CO}ₓO A OH wherein R is hydrogen, a saturated alkyl group having from about 1 to about 16 carbon atoms or an unsaturated alkyl group having from about 2 to about 16 carbon atoms or mixtures thereof, A is (CH₂)ₙ wherein n is about 2 to about 6 or A is (CH₂CHR′O)ₘ where R′ is hydrogen or methyl, m is from about 1 to about 25, y is 0 to about 3, and x is about 2 to about 25;
c) HOCHR(CH₂)_{y}COO A OOC(CH₂)_{y}CHROH wherein R is hydrogen, a saturated alkyl group having from about 1 to about 16 carbon atoms or an unsaturated alkyl group having from about 2 to about 16 carbon atoms or mixtures thereof, A is (CH₂)ₙ where n is about 2 to about 6 or A is (CH₂CHR′O)ₘ where R′ is hydrogen or methyl, m is from about 1 to about 25, and y is 0 to about 3;
d) H{OCHR(CH₂)_{y}CO}ₓ O A O {OC(CH₂)_{y}CHRO}ₓH wherein R is hydrogen, a saturated alkyl group having from about 1 to about 16 carbon atoms or an unsaturated alkyl group having from about 2 to about 16 carbon atoms or mixtures thereof, y is 0 to about 3, and x is about 2 to about 25, A is (CH₂)ₙ where n is about 2 to about 6 or, A is (CH₂CHR′O)ₘ where R′ is hydrogen or methyl, and m is from about 1 to about 25;
e) {HOCHR(CH₂)_{y}CO}_{z} B wherein R is hydrogen, a saturated alkyl group having from about 1 to about 16 carbon atoms or an unsaturated alkyl group having from about 2 to about 16 carbon atoms or mixtures thereof, y is 0 to about 3, and B is selected from:
   trimethylol propane and z is 1, 2, 3 or a mixture of 1, 2, and/or 3;
   glycerol where z is 1, 2, 3 or a mixture of 1, 2, and/or 3;
   triethanolamine where z is 1, 2, 3 or a mixture of 1, 2, and/or 3; or
   sucrose where z is from 1 to p wherein p is the number of free hydroxyl groups or derivatives on the compound containing at least two hydrogen atoms; and/or
f) [H{OCHR(CH₂)_{y}CO}ₓ]_{z} B wherein R is hydrogen, a saturated alkyl group having from about 1 to about 16 carbon atoms or an unsaturated alkyl group having from about 2 to about 16 carbon atoms or mixtures thereof, y is 0 to about 3, x is about 2 to about 25, and B is selected from:
   trimethylol propane and z is 1, 2, 3 or a mixture of 1, 2, and/or 3;
   glycerol where z is 1, 2, 3 or a mixture of 1, 2, and/or 3;
   triethanolamine where z is 1, 2, 3 or a mixture of 1, 2, and/or 3; or
   sucrose where z is 1 to p wherein p is the number of free hydroxyl groups or derivatives on the compound containing at least two hydrogen atoms.

Preferably, if B is sucrose in formulae e) and f), z is from 1 to (p−1).

Preferably, the monomer includes at least one structural unit selected from 3-hydroxypropionic acid, 3-hydroxybutyric acid, 3-hydroxyhexanoic acid, 3-hydroxyoctanoic acid, 4-hydroxybutyric acid, 4-hydroxybutanoic acid, homopolymers of such hydroxy acids, or blends of one or more of said hydroxy acids with 3-hydroxybutyric acid or with 4-hydroxybutyric acid. In addition, the monomer preferably includes at least one structural unit selected from ethylene glycol, 1,3 propane diol, 1,2 propane diol, 1,2 butane diol, 1,3 butane diol, and/or 1,4 butane diol. Alternatively, the monomer includes structural units of 3-hydroxy butyric acid combined with polyethylene glycol and preferably having from about 1 to about 25 ethylene glycol repeating units. The monomer can be, in general, an alkanoic acid ester ethoxylate monomer such as a monomer that includes polyethylene glycol repeat units. The monomer can also be a mixture of various hydroxyalkanoates such as a mixture of 3-hydroxybutyric acid and 3-hydroxyvaleric acid combined with ethylene glycol, 1,3 propane diol, 1,2 propane diol, 1,2 butane diol, 1,3 butane diol, 1,4 butane diol, or 1,2 propylene glycol or 1,3 propylene glycol preferably having from about 1 to about 25 ethylene glycol repeating units. The bis(hydroxy acid esters), for instance, those set forth in c) and d) above, can be formed from 2 motes of hydroxy acid reacting with one mole of diol.

According to a preferred embodiment of the present invention, the alkanoic acid ester monomers of the present invention can contain one or more units of the following formula:
T-[—OCR¹R²(CR³R⁴)ₙCO—]ₚ-Q
wherein n is 0 or an integer up to about 50; p is from about 0 to about 25; R¹, R², R³, and R⁴, which are the same as each other or different from one another, are each independently selected from saturated and unsaturated hydrocarbon radicals, halo- and hydroxy-substituted radicals, hydroxy radicals, halogen radicals, nitrogen-substituted radicals, oxygen-substituted radicals, or hydrogen atoms; Q is selected from:

a hydroxy radical or an OR″ radical wherein R″ is a substituted or unsubstituted alkyl, aryl, alkaryl, or aralkyl radical containing from 1 to about 20 carbon atoms, and R″ is preferably substituted;
OAOH;
OAOOC(CH₂)_{y}CHROH;
OAO{OC(CH₂)_{y}CHRO}ₓH; or

B, wherein R, A, B, x, and y are as defined above; and

T is selected from hydrogen, an alkyl, aryl, alkaryl, or aralkyl group containing from about 1 to about 20 carbon atoms, or an R′″COO carboxylate group wherein R′″ is an aliphatic or aromatic hydrocarbon radical containing from about 1 to about 20 carbon atoms. Preferably n is from about 0 to about 5 and more preferably from about 1 to about 3. Examples of R¹, R², R³, and/or R⁴ include, but are not limited to, hydrogen, methyl, ethyl, propyl, butyl, pentyl, hexyl, heptyl, octyl, nonyl, decyl, and the like, and combinations thereof. When used as a solvent or coalescing agent, n is preferably from about 0 to about 5 and p is preferably from about 0 to about 5. Homopolymers of the formula (VII) above and copolymers containing different polymers each having the formula (VII) above are also encompassed by the present invention.

The present invention also relates to dihydroxy alkanoic acid ester monomers, including monomers of the formulae (I)-(VII) shown above containing at least two hydroxy groups. Exemplary dihydroxy alkanoic acid ester monomers according to the present invention include monomers of the formulae (VII) above wherein Q represents a hydroxy-containing radical such as hydroxy-containing hydrocarbon radicals having at least one carbon atom, and T is a hydrogen atom.

The present invention also relates to a group of alkanoic acid ester monomers having a number average molecular weight ranging from about 100 to about 1000 and having one or more of the following formulae:
R′{OCHR(CH₂)ₙCO}ₘOCH₂CH₂OR′ (VIII)
wherein R represents a hydrogen atom or an alkyl group having from about 1 to about 18 carbon atoms, R′ represents a hydrogen atom or an acetate group, n is from about 1 to about 3, and m is from about 1 to about 3;
R′{OCHR(CH₂)ₙCO}ₘOCH₂CH(CH₃)OR′ (IX)
wherein R represents a hydrogen atom or an alkyl group having from about 1 to about 18 carbon atoms, R′ is a hydrogen atom or an acetate group, n is from about 1 to about 3, and m is from about 1 to about 3; or
R′{OCHR(CH₂)ₙCO}ₘOR″ (X)
wherein R represents a hydrogen atom or an alkyl group having from about 1 to about 18 carbon atoms, R′ represents a hydrogen atom or an acetate group, R″ represents a hydrogen atom or an alkyl group having from about 1 to about 10 carbon atoms, n is from about 1 to about 3, m is from about 1 to about 3, and said monomer has the following Hansen solubility parameters:

dispersive—from about 16 to about 22,

polar—from about 3 to about 12, and

hydrogen—from about 6 to about 17.

In particular, the alkanoic acid ester monomers of formulae (VIII)-(X) are well suited as solvents and are preferably biodegradable. The present invention also provides solutions that include a solute dissolved in or mixed with an alkanoic acid ester monomer of formula (VIII), (IX) or (X).

The present invention also relates to a group of alkanoic acid ester monomers having a number average molecular weight ranging from about 100 to about 1000 and having one or more of the following formulae:
R′(OCHR′CH₂)ₚ{OCHR(CH₂)ₙCO}ₘOR″ (XI)
wherein R represents a hydrogen atom or an alkyl group having from about 1 to about 18 carbon atoms, R′ represents a hydrogen atom or an acetate group, R″ is a hydrogen atom or an alkyl group having from about 1 to about 18 carbon atoms; n is from about 1 to about 3, m is from about 1 to about 30, and p is from about 1 to about 100;
R′{OCHR(CH₂)ₙCO}ₘOCH₂CHR″)_{q}OR″ (XII)
wherein R represents a hydrogen atom or an alkyl group having from about 1 to about 18 carbon atoms, R′ is a hydrogen atom or an acetate group, R″ represents a hydrogen atom or a methyl group, n is from about 1 to about 3, and m is from about 1 to about 30, and q is from about 1 to about 100; or
R′(OCHR′CH₂)ₚ{OCHR(CH₂)ₙCO}ₘ(OCH₂CHR″)_{q}OR″ (XIII)
wherein R represents a hydrogen atom or an alkyl group having from about 1 to about 18 carbon atoms, R′ represents a hydrogen atom or a methyl group, R″ represents a hydrogen atom or an alkyl group having from about 1 to about 18 carbon atoms, n is from about 1 to about 3, m is from about 1 to about 30, p is from about 1 to about 100, and q is from about 1 to about 100.

In particular, the alkanoic acid ester monomers of formulae (XI)-(XIII) are well suited as surface active agents and are preferably biodegradable. The present invention also provides solutions or liquid mixtures that include an alkanoic acid ester monomer surface active agent of formula (XI), (XII) or (XIII).

The present invention also relates to a method for producing biologically degradable alkanoic acid ester monomers by hydrolyzing polyhydroxyalkanoates, preferably under conditions that produce low molecular weight monomers (number average molecular weight of about 1,000 or less), and preferably under conditions that produce monomers of the formulae (I)-(X) shown above.

Several types of polyhydroxyalkanoates (PHAs) can be hydrolyzed to form the alkanoic acid ester monomers of the present invention, including natural and synthetically-derived PHAs. It is useful to broadly divide the PHAs into two groups according to the length of their side chains and according to their pathways for biosynthesis. Those with short side chains, such as polyhydroxybutyrate (PHB), a homopolymer of R-3-hydroxybutyric acid units, are crystalline thermoplastics; PHAs with long side chains are more elastomeric. The former polymers have been known for about seventy years (Lemoigne & Roulhelman 1925), while the latter polymers are a relatively recent discovery (deSmet, et al., J. Bacteriol., 154:870-78 (1983)). Before this designation, however, PHAs of microbial origin containing both R-3-hydroxybutyric acid units and longer side chain units from C5 to C16 were identified (Wallen & Rowheder, Environ. Sci. Technol., 8:576-79 (1974)). A number of bacteria which produce copolymers of D-3-hydroxybutyric acid and one or more long side chain hydroxyacid units containing from five to sixteen carbon atoms have been identified more recently (Steinbuchel & Wiese, Appl. Microbiol Biotechnol., 37:691-97 (1992); Valentin et al. Appl. Microbiol. Biotechnol., 36: 507-14 (1992); Valentin et al., Appl. Microbiol. Biotechnol., 40:710-16 (1994); Abe et al., Int. J. Biol Macromol, 16:115-19 (1994); Lee et al., Appl. Microbiol. Biotechno., 42:901-09 (1995); Kato et al., Appl. Microbiol. Biotechnol., 45:363-70 (1996); Valentin et al., Appl. Microbiol. Biotechnol., 46:261-67 (1996); U.S. Pat. No. 4,876,331 to Doi). Useful examples of specific two-component copolymers include PHB-co-3-hydroxyhexanoate (Brandl et al., Int. J. Biol Macromol, 11:49-55 (1989); Amos & McInerey, Arch. Microbiot, 155:103-06 (1991); U.S. Pat. No. 5,292,860 to Shiotani et al). Chemical synthetic methods have also been applied to prepare racemic PHB copolymers of this type for applications testing (WO 95/20614, WO 95/20615, and WO 96/20621).

As PHAs have become increasingly available, they have been examined for their suitability in applications where they serve as a processing aid. For example, the use of PHA latex film in the production of CRT tube components is described in WO 96/17369.

Preferred PHA starting materials for making the alkanoic acid ester monomers of the present invention include, but are not limited to, polyhydroxyalkanoate homopolymers; polyhydroxybutyrate; a copolymer of hydroxybutyric acid and hydroxyvaleric acid (e.g., a copolymer of 1-99 weight % hydroxy butyric acid and 1-99 weight % hydroxyvaleric acid); a copolymer of 3-hydroxybutyric acid and 4-hydroxybutyric acid (e.g., a copolymer of 1-99 weight % 3-hydroxybutyric acid and 1-99 weight % 4-hydroxybutyric acid); polyhydroxy-hexanoate; polyhydroxyoctanoate; a copolymer containing hydroxyhexanoate or hydroxyoctanoate groups randomly distributed through the polymer chain (e.g., at least 10% by molar mass hydroxyoctanoate groups randomly distributed through the polymer chain of a copolymer); and combinations thereof. The polyhydroxyalkanoate can also have end chain functionalities such as groups selected from vinyl; carboxylic acid; carboxylic acid ester; acetate; butyrate; propanoate; primary, secondary, or tertiary alcohol; amide; and/or a polyhydric alcohol.

The PHA starting material can also have the formula

R⁵CH═CH(CH₂)ₙ₋₁CO[OCHR⁶(CH₂)ₙCO]ₚOH. Alternatively, the PHA starting material can have the formula H[OCHR⁷(CH₂)ₙCO]ₚOR′. Further, the PHA starting material can have the formula R″CO[OCHR⁸(CH₂)ₙCO]ₚOH. The PHA starting material can also be a block polymer containing polyhydroxyalkanoate segments and at least one polyalkylene glycol segment. Preferably, for such a PHA, the block polymer preferably contains at least 20 weight % of a PHA segment and at least one polyalkylene glycol segment selected from one or more repeat units of ethylene oxide, propylene oxide, butylene oxide, or mixtures thereof. In the above formulae, p is from 2 to 1000 and more preferably from 5 to 1000, n is 0 or an integer, R′ is derived from a monohydric alcohol or a polyhydric alcohol, such as methyl-styryl, and R″ is derived from a carboxylic acid having 1 to 20 carbon atoms, such as methyl-styryl, R⁵, R⁶, R⁷, and R⁸ can represent saturated or unsaturated hydrocarbon radicals; halo, hydroxy, oxygen or nitrogen substituted radicals; or hydrogen atoms, such as H, CH₃, C₂H₅, C₃H₇, C₄H₉, or C₅H₁₁.

In another embodiment, biodegradable PHA starting materials to make the alkanoic acid ester monomers of the present invention can have at least one of the terminal end groups selected from:
—CO—CH═CR⁹R¹⁰
—OR¹¹
—COOR¹²
—COR¹³; or
—O⁻M⁺

wherein R⁹, R¹⁰, R¹¹, R¹², or R¹³, which are the same or different represent saturated or unsaturated hydrocarbon radicals, halo- or hydroxy-substituted radicals, hydroxy radicals, nitrogen-substituted radicals, oxygen-substituted radicals, or a hydrogen atom, with the proviso that R¹¹ is not a hydrogen atom. M⁺ is a counterion, such as, but not limited to, ammonium, and metal counterions, like sodium, potassium, zinc, calcium, and the like. Preferably, both of the terminal end groups of the PHA are selected from one of the above-described terminal end groups a)-e) wherein the terminal end groups can be the same or different. Alternatively, the PHA can have one of the above-described terminal end groups a)-e) and the other terminal end group can be hydrogen or —OH. Preferably, when the terminal end group is —OR¹¹, or —COR¹³, the other end group is not —OH. These various terminal end groups can be the terminal end groups for the PHA formula (IV) set forth and described above. These biodegradable polyhydroxyalkanoates can have any molecular weight such as a number average molecular weight of from about 500 to about 1.5 million. More preferably, the number average molecular weight is from about 500 to about 500,000, more preferably from about 500 to less than 200,000, such as from about 500 to about 80,000. These polyhydroxyalkanoates can be polymers, oligomers, or monomers.

Preferably, the PHA starting material has a number average molecular weight in excess of 80,000, for example, in excess of 100,000.

Preferred PRAs that can be hydrolyzed to form the alkanoic acid ester monomers of the present invention include the following PHA formulae wherein the various variables are as described above unless noted differently below.
H(OCHRCH₂CO)ₙOH

H(OCHRCH₂CO)ₙOR′ where R′ is preferably an alkyl group or substituted alkyl group (e.g. diol, polyol, etc)

H(OCHRCH₂CO)ₘO⁻M⁺ where M⁺ is preferably selected from ammonium, sodium, potassium, zinc, and calcium

R″CO(OCHRCH₂CO)ₘOH where R″ is preferably the alkyl group from an aliphatic carboxylic acid

R″CO(OCHRCH₂CO)ₘOR′ where R″ is preferably the alkyl group from an aliphatic carboxylic acid and R′ is preferably an alkyl group or substituted alkyl group (e.g. diol, polyol, etc.)

R″CO(OCHRCH₂CO)ₙO⁻M⁺ where R″ is preferably the alkyl group from an aliphatic carboxylic acid and M⁺ is preferably selected from ammonium, sodium, potassium, zinc, and calcium.

The PHA starting material used to form the alkanoic acid ester monomers of the present invention can be prepared from a biological source such as a microorganism which naturally produces the PHAs or which can be induced to produce the PHAs by manipulation of culture conditions and feedstocks, or microorganisms or a higher organism such as a plant which has been genetically engineered so that it produces PHAs.

Methods which can be used for producing PHA starting material polymers from microorganisms which naturally produce polyhydroxyalkanoates are described in U.S. Pat. No. 4,910,145 to Holmes, et al.; Byrom, “Miscellaneous Biomaterials” in Biomaterials (Byrom, ed.) pp. 333-59 (MacMillan Publishers, London 1991); Hocking and Marchessault, “Biopolyesters” in Chemistry and Technology of Biodegradable Polymers (Griffin, ed.) pp. 48-96 (Chapman & Hall, London 1994); Holmes, “Biologically Produced (R)-3-hydroxyalkanoate Polymers and Copolymers” in Developments in Crystalline Polymers (Bassett, ed.) vol. 2, pp. 1-65 (Elsevier, London 1988); Lafferty et al., “Microbial Production of Poly-b-hydroxybutyric acid” in Biotechnology (Rehm & Reed, eds.) vol. 66, pp. 135-76 (Verlagsgesellschaft, Weinheim 1988); Müller & Seebach, Angew. Chem. Int. Ed. Engl. 32:477-502 (1993).

Methods for producing starting material PHAs in natural or genetically engineered organisms are described by Steinbüchel, “Polyhydroxyalkanoic Acids” in Biomaterials (Byrom, ed.) pp. 123-213 (MacMillan Publishers, London 1991); Williams & Peoples, CHEMTECH, 26:38-44 (1996); Steinbüchel & Wiese, Appl. Microbiol. Biotechnol., 37:691-97 (1992); U.S. Pat. Nos. 5,245,023; 5,250,430; 5,480,794; 5,512,669; 5,534,432 to Peoples and Sinskey; Agostini et al, Polym. Sci., Part A-1, 9:2775-87 (1971); Gross et al., Macromolecules, 21:2657-68 (1988); Dubois, et al., Macromolecules, 26:4407-12 (1993); Le Borgne & Spassky, Polymer, 30:2312-19 (1989); Tanahashi & Doi, Macromolecules, 24:5732-33 (1991); Hori et al., Macromolecules, 26:4388-90 (1993); Kemnitzer et al., Macromolecules, 26:1221-29 (1993); Hori et al., Macromolecules, 26:5533-34 (1993); Hocking & Marchessault, Polym. Bull., 30:163-70 (1993); Xie et al., Macromolecules, 30:6997-98 (1997); and U.S. Pat. No. 5,563,239 to Hubbs et al. Other polymer synthesis approaches including direct condensation and ring-opening polymerization of the corresponding lactones are described in Jesudason & Marchessault, Macromolecules 27:2595-602 (1994); U.S. Pat. No. 5,286,842 to Kimura; U.S. Pat. No. 5,563,239 to Hubbs et al.; U.S. Pat. No. 5,516,883 to Hori et al.; U.S. Pat. No. 5,461,139 to Gonda et al.; and Canadian Patent Application No. 2,006,508. WO 95/15260 describes the manufacture of PHBV films, and U.S. Pat. Nos. 4,826,493 and 4,880,592 to Martini et al. describe the manufacture of PHB and PHBV films. U.S. Pat. No. 5,292,860 to Shiotani et al. describes the manufacture of the PHA copolymer poly(3-hydroxybutyrate-co-3-hydroxyhexanoate).

As starting materials, PHAs can exist in at least two distinct physical forms, as amorphous granules or as crystalline solids. The tendency of the PHAs to crystallize in terms of both final degree of crystallinity and rates of crystallization also varies with composition. PHA polymers offering rapid crystallization can be used for high green strength. These would include, for example PHB and PHBV, with the latter copolymer exhibiting the unique feature of isodimorphism. Where higher malleability is desired, PHOs and other longer pendant group types could be used. This polymer class has a lower glass transition temperature, around −35° C. as compared to 5° C. for the PHB homopolymer, allowing them to be formulated as self lubricating. This in turn reduces the need for other additives to obtain suitable flow characteristics for the mixture fed to the shaping system.

The PHA starting material compositions also have various solubilities in organic solvents, and thus the choice of starting materials allows for a choice of a wide range of solvents. Copolymers of D-3-hydroxybutyrate and other hydroxyacid co-monomers have significantly different solubility characteristics from those of the PHB homopolymer. For example, acetone is not a good solvent for PHB but is very useful for dissolving D-3-hydroxybutyrate copolymers with D-3-hydroxyacids containing from 6 to 12 carbon atoms (Abe et al., Int. J. Biol. Macromol. 16:115-19 (1994); Kato et al., Appl. Microbiol. Biotechnol., 45:363-70 (1996)). Mitomo et al., Reports on Progress in Polymer Physics in Japan, 37:128-29 (1994), describes the solubility of copolyesters poly(3-hydroxybutyrate-co-4-hydroxybutyrate, containing from 15 to 75 mol. % 4-hydroxybutyrate residues, in acetone. A number of other solvents suitable for a range of PHAs are described in U.S. Pat. No. 5,213,976 to Blauhut et al.; U.S. Pat. No. 4,968,611 to Traussnig; Japan Kokai Tokkyo Koho JP 95,135,985; Japan Kokai Tokkyo Koho JP 95,79,788; WO 93/23554; DE 19533459; WO 97/08931; and Brazil Pedido PI BR 93 02,312.

The alkanoic acid ester monomers of the present invention can be prepared, for instance, by first using a PHA starting material as described above and subjecting the starting material to an acid hydrolysis which will result in a lower molecular weight alkanoic acid ester monomer according to the present invention. The acid hydrolysis preferably occurs in the presence of an alcohol, a diol, or a polyhydric alcohol, or combinations thereof. The preferred conditions for the acid hydrolysis and the preferred amounts of the components in this reaction are as follows. When an excess amount of alcohol, diol, or polyol is used, the PHA starting material will form a low molecular weight dihydroxy alkanoic acid ester monomer, such as a monomer having a number average molecular weight of about 1000 or less, with hydroxyl groups in both terminal positions. An excess of polyol favors the production of dihydroxyalkanoic acid ester monomers, particularly under acid hydrolysis conditions that last a number of hours. The reaction conditions are controlled such that preferably at least 1% by weight residual alcohol, diol, or polyol remains in the reaction product. For example, the controlled hydrolysis of polyhydroxybutyrate in the presence of ethylene glycol or 1,4 butane diol produces oligomers with the structure:

For ethylene glycol:
H(—OCH(CH₃)CH₂CO)ₙOCH₂CH₂OH;
and for 1,4 butane diol:
H(O—CH(CH₃)CH₂CO)ₙOCH₂CH₂CH₂CH₂OH;
wherein n is preferably from about 2 to about 50.

If an excess of an alcohol is used in the hydrolysis process then a hydroxy ester is obtained, which for polyhydroxybutyrate in the presence of methanol, would have the structure:
H—(OCH(CH₃)CH₂CO)ₘOCH₃.

According to preferred embodiments of the present invention, a starting material PHA can be converted into the alkanoic acid ester monomers of the present invention by a process that includes the dissolution of the PHA in a non-halogenated solvent, for example, an alcohol, diol, or preferably, a polyol. Then, the dissolved starting material is subjected acid hydrolysis as discussed above to form the alkanoic acid ester monomers of the present invention.

The hydrolysis of polyhydroxyalkanoates can occur in the presence of a strong acid catalyst such as sulfuric acid, hydrochloric acid or phosphoric acid; the most preferable being sulfuric or hydrochloric acids. The resultant monomers contain a terminal hydroxyl and carboxylic acid groups. If the reaction is carried out in the presence of a strong acid catalyst and an alcohol, then the monomers will have terminal hydroxyl and ester groups. If the reaction is carried out in the presence of a strong acid catalyst and a carboxylic acid, then the monomers will have an ester group generated from the carboxylic acid and the hydroxyl group on the monomers, and a free carboxylic acid. Other hydrolysis reactions of polyhydroxyalkanoates can be catalyzed by metal transesterification catalysts, including titanium, or metal alkoxide transesterification catalysts. Alkoxides of Group I A metals or Group III A metals are exemplary metal oxide transesterification catalysts that can be used for hydrolysis.

While the acid hydrolysis reaction can occur under ambient temperatures, elevated temperatures are normally utilized to increase the reaction rate. For the acid hydrolysis of polyhydroxyalkanoates, the most preferable reaction temperature conditions are from about 70° C. to about 140° C. In an embodiment of the present invention, acid hydrolysis reactions occurring above 140° C. typically have a mixture of terminal hydroxyl and vinyl groups as well as the free acid or ester group.

The alkanoic acid ester monomers of the present invention can be plasticized and blended with other polymers or agents. Other, non-microbial, polymers having structures and decomposition temperatures similar to polyhydroxyalkanoates include polylactide (PLA) and polyglycolide (PGA). The production and use of PLA are described extensively by Kharas et al., “Polymers of Lactic Acid” in Plast Microbes (Mobley, ed.) pp. 93-137 (Hanser, Munich, Germany (1994)). The ester oxygens of these polymers, PHAs, PLA, PGA, are polar and provide good bonding with other compositional components.

According to another embodiment of the present invention, a liquid mixture, for example, a latex composition, is provided that contains a coalescing agent which includes an alkanoic acid ester monomer according to the present invention. The low molecular weight alkanoic acid ester monomers of the present invention are useful as coalescing agents for a number of reasons. When used as a coalescing agent, the monomers can reduce the minimum film formation temperature of a film forming composition such as a paint or coating composition. In addition, the monomer can reduce the glass transition temperature of many compositions including many latex paint and coating compositions. The monomers of the present invention tend to be migratory and hence eventually rise to the surface of a film formed from a film forming composition and disappear or evaporate, for example, over a period of from about 1 to about 5 days. In addition, the monomers of the present invention act as adhesion promoters and promote the adhesion of solvent based inks such as lithographic and gravure inks, as well as promoting the adhesion of solvent based paints and coatings, epoxide-based paints and coatings.

When used as a coalescing agent the monomers of the present invention preferably exhibit a number average molecular weight of under 1000. An exemplary monomer useful as a coalescing agent according to the present invention is the monomer of formula (VII) shown above, wherein n is from about 0 to about 5 and p is from about 1 to about 5.

According to yet another embodiment of the present invention, methods are provided for coalescing components from a mixture, for example, from a liquid mixture. The methods involve combining the mixture with an alkanoic acid ester monomer or composition thereof, according to the present invention. The alkanoic acid ester monomers of the present invention exhibit coalescing properties, particularly toward components in latexes. The alkanoic acid ester monomers of the present invention can be used as coalescing agents in many applications. Latex compositions comprising an emulsion or suspension of polymer particles such as resins or elastomers in an aqueous medium, are widely used in various applications, e.g., coatings such as paints and clear coatings, adhesives, and dipping and impregnating compositions, and can benefit from the inclusion of a coalescing agent according to the present invention. For all or most of these applications, the latex must be capable of forming a strong, adherent and continuous film at a reasonably low temperature. In order to achieve these properties, a coalescing agent that includes the alkanoic acid ester monomer of the present invention can be combined with or added to the latex and preferably acts as a partial solvent for the polymer, i.e., the resin or elastomer, particles serving as the film forming constituent of the composition. The solvent action of the coalescing agent of the present invention on the emulsified or suspended particles allows them to coalesce into a strong, adherent and continuous film at a temperature sufficiently low to maintain the utility of the composition for its contemplated applications, e.g., exterior paints which are intended to be suitable for use in hot or cold weather, as well as interior paints which are generally exposed to more moderate temperatures.

In liquid mixture and latex compositions, the coalescing solvent of the present invention is preferably used in an amount of from about 0.05% by weight to about 25% by weight based on the total weight of the liquid mixture or latex composition, more preferably, from about 0.05% by weight to about 5% by weight. Preferably, the monomer of the present invention can act as a solvent, a coalescing agent, and an adhesion promoter all in one.

According to yet another embodiment of the present invention, the alkanoic acid ester monomer of the present invention is used as an environmentally-friendly “green” solvent exhibiting low toxicity. The solvent may consist of the alkanoic acid ester monomer of the present invention by itself or combined with other conventional solvent components known to those skilled in the art. A solute, for example, an alkyd paint, a latex paint, an acrylic polymer, an acetate polymer, a chlorinated natural rubber, a polyurethane, an epoxide, a polysulfide material, a silicone, or the like, can be mixed with or dissolved in a solvent that includes the alkanoic acid ester monomer of the present invention to form a solution. After a processing operation such as a coating, extraction or purifying operation, or some other treatment, the solution or solvent can be recovered and disposed of and subsequently biodegraded in an environmentally-friendly manner. The “green” solvent can be used in conventional amounts and can be introduced using conventional techniques.

The alkanoic acid ester monomers of the present invention can also be used to plasticize polymeric compositions, for example, polymeric compositions including one or more polymer selected from polyvinylacetates, polyvinylchlorides, polyesters, polyamides, and polystyrenes. Methods of plasticizing polymeric compositions are also provided according to the present invention and include combining a plasticizing amount of an alkanoic acid ester monomer of the present invention with a polymeric composition, preferably a polymeric composition comprising at least one of a polyvinyl acetate, a polyvinylchloride, a polyester, a polyamide, and a polystyrene. Preferably, from about 0.01 to about 30% by weight plasticizer can be used based on the weight of the polymeric composition. In particular, one method of plasticizing according to the present invention involves combining an alkanoic acid ester monomer of any of formulae (I)-(VII) with a polymeric composition to plasticize the composition. According to another method of the present invention, an alkanoic acid ester monomer of any of formulae (VIII)-(X) or of any of formulae (XI)-(XIII) is combined with a polymeric composition to plasticize the composition.

Other embodiments of the present invention will be apparent to those skilled in the art from consideration of the specification and practice of the invention disclosed herein. It is intended that the specification and examples be considered as exemplary only, with a true scope and spirit of the invention being indicated by the following claims.

1-24. (canceled)

25. A method of making an alkanoic acid ester monomer having a number average molecular weight of about 1000 or less, comprising hydrolyzing a polyhydroxyalkanoate under conditions to form an alkanoic acid ester monomer.

26. The method of claim 25, wherein said monomer is biodegradable.

27. The method of claim 25, wherein said polyhydroxyalkanoate is hydrolyzed in the presence of a stoichiometrically excessive amount of an alcohol, diol, or polyol.

28. The method of claim 25, wherein said polyhydroxyalkanoate is hydrolyzed in the presence of a stoichiometrically excessive amount of a polyol.

29. The method of claim 25, wherein said polyhydroxyalkanoate has a number average molecular weight in excess of 80,000.

30. The method of claim 25, wherein said polyhydroxyalkanoate is acid hydrolyzed.

31. The method of claim 30, wherein said polyhydroxyalkanoate is acid hydrolyzed at a temperature of from about 70° C. to about 140° C.

32. The method of claim 25, wherein said alkanoic acid ester monomer contains one or more units of the formula:
T-[—OCR¹R²(CR³R⁴)ₙCO—]ₚ-Q
wherein n is 0 or an integer up to about 50; p is from about 0 to about 25; R¹, R², R³, and R⁴, which are the same as each other or different from one another, are each independently selected from saturated and unsaturated hydrocarbon radicals, halo- and hydroxy-substituted radicals, hydroxy radicals, halogen radicals, nitrogen-substituted radicals, oxygen-substituted radicals, or hydrogen atoms; T is selected from hydrogen, an alkyl aryl, alkaryl, or aralkyl group containing from about 1 to about 20 carbon atoms, or an R′″COO carboxylate group wherein R′″ is an aliphatic or aromatic hydrocarbon radical containing from about 1 to about 20 carbon atoms; and Q is selected from:
a hydroxy radical or an OR″ radical wherein R″ is a substituted or unsubstituted alkyl, aryl, alkaryl, or aralkyl radical containing from 1 to about 20 carbon atoms;
OAOH;
OAOOC(CH₂)_{y}CHROH;
OAO{OC(CH₂)_{y}CHRO}ₓH; or
B;
wherein each R is independently selected from hydrogen, a saturated alkyl group having from about 1 to about 16 carbon atoms, an unsaturated alkyl group having from 2 to 16 carbon atoms, or mixtures thereof; A is (CH₂)ₘ or (CH₂CHR′O)ₘ, where m is from about 1 to about 25 and R′ is hydrogen or methyl; x is from about 2 to about 25; y is from 0 to about 3; and B is selected from:
trimethylol propane when z is 1, 2, 3 or a mixture of 1, 2, and/or 3,
glycerol when z is 1, 2, 3 or a mixture of 1, 2, and/or 3,
triethanolamine when z is 1, 2, 3 or a mixture of 1, 2, and/or 3, or
sucrose when z is 1 to p where p is the number of free hydroxyl groups
or derivatives present in said compound.

33. The method of claim 32, wherein n is from about 1 to about 3 and R¹, R², R³, and R⁴, which are the same or different, are each selected from hydrogen, methyl, ethyl, propyl, butyl, pentyl, hexyl, heptyl, octyl, nonyl, decyl, and combinations thereof.

34-55. (canceled)
